(19) United States
(12) Patent Application Publication
(10) Pub. No.: US 2022/0303601 A1
(43) Pub. Date: Sep. 22, 2022

(54) APPARATUSES AND METHODS FOR ENHANCING A QUALITY OF A PRESENTATION OF CONTENT

(71) Applicant: AT&T Intellectual Property I, L.P., Atlanta, GA (US)

(72) Inventors: Eric Zavesky, Austin, TX (US); James H. Pratt, Round Rock, TX (US)

(73) Assignee: AT&T Intellectual Property I, L.P., Atlanta, GA (US)

(21) Appl. No.: 17/205,000

(22) Filed: Mar. 18, 2021

(51) Int. Cl. H04N 21/258; H04W 4/02; H04W 12/06; H04N 21/6587

(52) U.S. Cl. CPC H04N 21/25841; H04W 4/025; H04W 12/06; H04N 21/6587

(57) ABSTRACT

Aspects of the subject disclosure may include, for example, identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. Other embodiments are disclosed.

### FIELD OF THE DISCLOSURE

The subject disclosure relates to apparatuses and methods for enhancing a quality of a presentation of content.

### BACKGROUND

As the world increasingly becomes connected via vast communication networks and systems, additional opportunities are generated to provision content to users of such networks/systems. In situations where context matters, large displays of information (such as billboards, projector screens, and the like) tend to be static in nature (e.g., tend to assume fixed positions/locations) and may require costly/complex infrastructure for support or mounting purposes. Still further, in many instances content that is provisioned lacks synchronization with respect to various parameters that are dynamic in nature. In this regard, the effectiveness of a rendering of content is diminished/degraded.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a communication system that facilitates one or more methodological operations in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for controlling parameters associated with a communication system in relation to a presentation of one or more content items. Other embodiments are described in the subject disclosure.

One or more aspects of the subject disclosure include, in whole or in part, receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment.

One or more aspects of the subject disclosure include, in whole or in part, identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item.

One or more aspects of the subject disclosure include, in whole or in part, causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

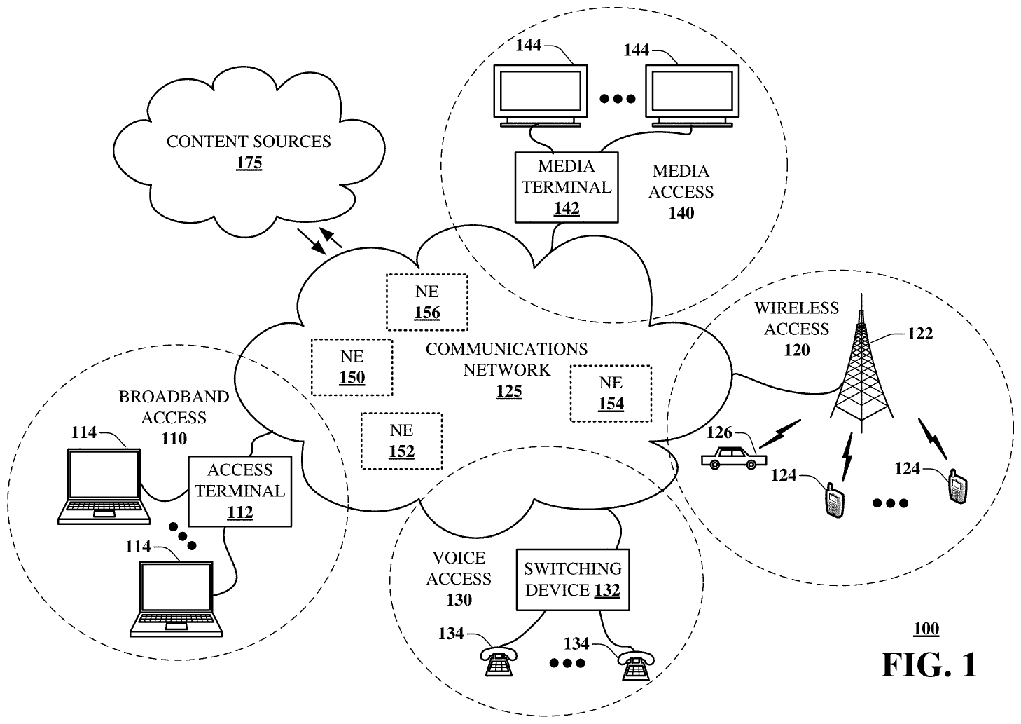

Referring now to FIG. 1, a block diagram is shown illustrating an example, non-limiting embodiment of a system 100 in accordance with various aspects described herein. For example, system 100 can facilitate in whole or in part receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment. System 100 can facilitate in whole or in part identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. System 100 can facilitate in whole or in part causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

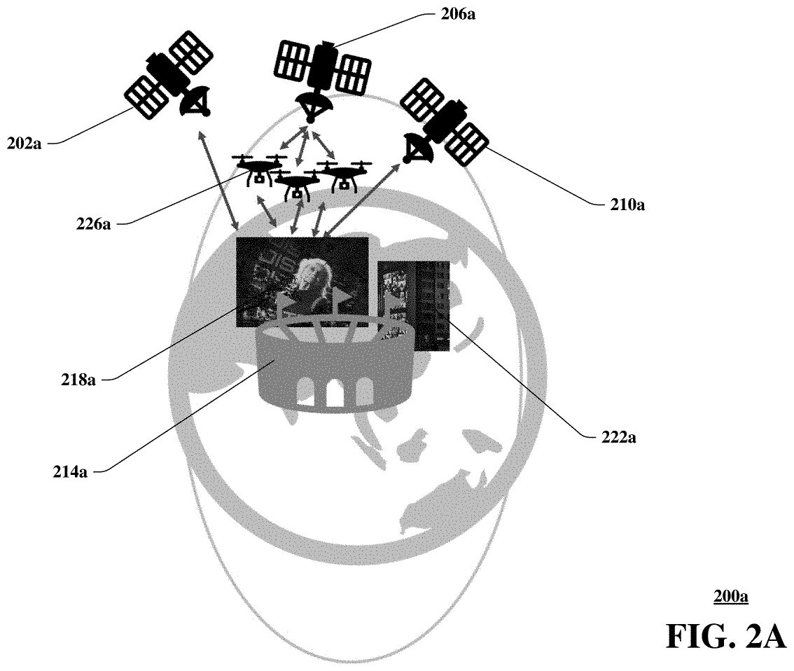

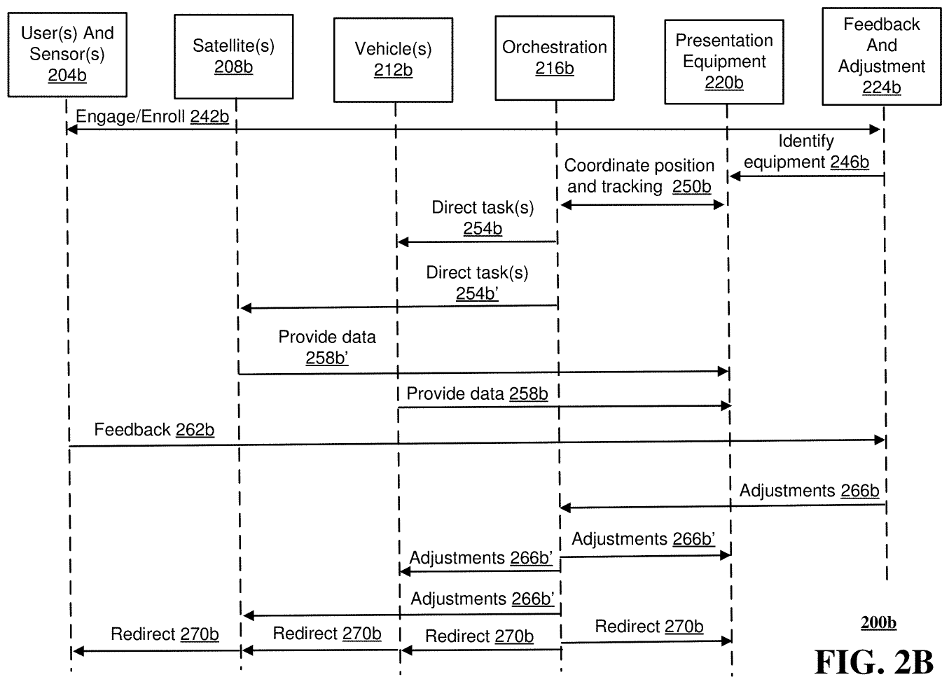

FIG. 2A is a block diagram illustrating an example, non-limiting embodiment of a system 200a. The system 200a may function within, or may be operatively overlaid upon, the communication network 100 of FIG. 1 in accordance with various aspects described herein. The system 200a may include/incorporate one or more satellites, such as for example a first satellite 202a, a second satellite 206a, and a third satellite 210a. The use of three satellites (202a-210a) in FIG. 2A is illustrative; in some embodiments, more or fewer than three satellites may be used.

As part of the illustrative embodiment represented by the system 200a, the satellites 202a-210a may provide data associated with a presentation/rendering of content/content items in respect of a stadium/arena 214a. The stadium 214a may be outfitted with/include one or more projection screens or displays, such as for example a first display screen 218a and a second display screen 222a. The data may be transmitted by the satellites 202a-210a to facilitate a visual rendering on the display 218a and/or the display 222a. The use of the displays 218a and 222a is illustrative/exemplary; in some embodiments, other types/kinds of surfaces, inclusive of other surfaces of a kind/type commonly found in a stadium (such as a wall, a field or court, etc.) may be used to facilitate a visual presentation. In some embodiments, the display 218a can be natural or artificially created clouds, mist, fog, or other semi-transparent medium. While the final display surface of interest is oriented towards the stadium audience 214a, the display may also utilize multiple depths within the medium for creation of the image. In some embodiments, the stadium 214a may include audio equipment (e.g., loudspeakers, amplifiers, etc.), and at least a portion of the data provisioned within the system 200a (e.g., by the satellites 202a-210a) may facilitate an audio rendering/presentation.

In some embodiments, one or more vehicles may be used to transmit at least a portion of the data for a presentation/rendering. For example, one or more drones (e.g., a drone 226a) may be used to provide at least a portion of the data. In some embodiments, data provided by the drone(s) may be pre-loaded or downloaded to the drone(s), and then the drone(s) may be dispatched in accordance with a schedule associated with a rendering/presentation of content. In some embodiments, the drone(s) may obtain at least some of the data from one or more of the satellites 202a-210a; stated differently, the drone(s) may effectively serve as a conduit/communication channel between the satellites 202a-210a and the presentation equipment/surfaces (e.g., displays 218a and 222a). In some embodiments, the drone(s) may transform the data obtained from the satellites 202a-210a before transmitting the obtained data to the presentation equipment/surfaces. Transformation in this context may include, without limitation, applying error correction to the data, amplifying a signal associated with the data, applying a phase shift to the signal, utilizing a different frequency/frequency band in respect of the signal, engaging one or more beamforming algorithms in respect of the signal, etc.

In some embodiments, satellites may obtain data from drones, and the obtained data may be provided to presentation equipment. In some embodiments, satellites may exchange data with one another. In some embodiments, drones may exchange data with one another. Satellites and drones (or any communication devices associated therewith) may be interchangeable with one another, based on functionality, location (e.g., altitude), etc.

FIG. 2B depicts an illustrative embodiment of a communication system 200b. The system 200b may function within, or may be operatively overlaid upon, the communication network 100 of FIG. 1 in accordance with various aspects described herein. While shown separately for the sake of ease and convenience in illustration, in some embodiments one or more aspects of the system 200a may be combined with one or more aspects of the system 200b.

Aspects of the system 200b may be implemented or executed in conjunction with one or more devices (e.g., communication devices, such as satellites, servers, gateways, modems, routers, switches, access points, user equipment, etc.) and/or vehicles (e.g., aircraft, spacecraft, terrestrial vehicles (e.g., automobiles), marine vehicles (e.g., boats, ships, submarines), etc.). In some embodiments, the system 200b may be configured to implement/execute one or more methods or methodological acts. In this regard, various operations associated with such methods/methodological acts are represented/illustrated by the arrows shown in FIG. 2B and are discussed in further detail below.

The system 200b may include one or more users and/or one or more sensors 204b, one or more satellites 208b, one or more vehicles 212b, an orchestration component/module 216b, one or more pieces/items of presentation equipment 220b, and a feedback and adjustment component/module 224b. While shown separately in FIG. 2B, in some embodiments two or more of the entities (e.g., the orchestration component 216b and the feedback and adjustment component 224b) may be included/incorporated as part of a common housing, casing, or enclosure.

In an operation 242b, the one or more users 204b may engage or enroll in a service provided by the system 200b. For example, a user may subscribe to the service as part of the operation 242b and/or may supply one or more credentials (e.g., a username and password, a personal identification number (PIN), a biometric credential (e.g., a retinal scan, an image or video for application of a facial recognition technique, etc.) that may distinguish the user from other users. In some embodiments, the engagement/enrollment of the operation 242b may include a request from a user for specific content (such as for example in relation to a selection from: a menu, search results, an electronic programming guide (EPG), an interactive programming guide (IPG), and the like). In some embodiments, the engagement/enrollment operation 242b may include a request for a recommendation/suggestion for content that may be of interest to the user (or a set of users).

As part of the operation 242b, the one or more sensors 204b may register with the service. Registration in this context may include a sensor 204b identifying itself as being available for accommodating/facilitating at least a part of the service. Without limitation, the sensors 204b may include one or more cameras, motion sensors, audio equipment (e.g., one or more microphones), environmental sensors (e.g., temperature sensors, pressure sensors, humidity sensors, wind sensors), etc.

Based on the engagement/enrollment of the operation 242b, the feedback and adjustment component 224b may identify the presentation equipment 220b to be utilized as part of an operation 246b. The operation 246b may include the feedback and adjustment component 224 instructing/directing the presentation equipment 220b to turn-on or activate. In other embodiments, the enrollment process 242b may also contain a profile or description of user capabilities or limitations; for example, the user may be partially colorblind or near-sighted and these details will be conveyed to the feedback and adjustment module 224b.

As part of an operation 250b, the presentation equipment 220b may provide information to enable the orchestration component 216b to have knowledge regarding parameters of the presentation equipment 220b. For example, and assuming that the presentation equipment 220b includes a projection screen, a position of the projection screen, an orientation of the projection screen, a size/dimension of the projection screen, etc., may be conveyed as part of the operation 250b. To the extent that parameters of the presentation equipment 220b are capable of being controlled (such as for example via one or more actuators, motors, or the like), the operation 250b may include one or more commands/directives that may cause the presentation equipment 250b to assume a given value in respect of one or more of the parameters. In other embodiments, the displays 218a or 214a which may be derived from a semitransparent medium may be adjusted as part of the presentation equipment 220b with additional material, lighting, thickness, or transparency to accomplish different visual and audio modifications of the signal.

In an operation 254b, the orchestration component 216b may direct the vehicle(s) 212b to engage in one or more tasks. For example, and assuming that the vehicles 212b include a drone, the tasks of operation 254b may include the drone relocating to a specified location, at a specified height above the Earth's surface. One or more communication parameters (e.g., frequency/frequency bands, power levels, modulation/demodulation schemes, security schemes (e.g., encryption/decryption schemes), etc.) associated with the drone may be assigned/allocated as part of the operation 254b.

In an operation 254b′, the orchestration component 216b may direct the satellite(s) 208b to engage in one or more tasks. For example, the tasks of operation 254b′ may include a satellite 208b relocating to a specified location, at a specified height (e.g., a specified orbital location) above the Earth's surface. One or more communication parameters (e.g., frequency/frequency bands, power levels, modulation/demodulation schemes, encryption/decryption schemes, etc.) associated with the satellite(s) 208b may be assigned as part of the operation 254b′.

In an operation 258b′, the satellite(s) 208b may provide at least a portion of the data to accommodate a presentation or rendering of content, such as for example content identified as part of the operation 242b. Similarly, as part of an operation 258b, the vehicle(s) 212b may provide at least a portion of the data to accommodate the presentation/rendering of content. The data associated with the operations 258b and 258b′ may be provided to, e.g., the presentation equipment 220b.

Based on obtaining the data associated with the operation 258b and/or the operation 258b′, the presentation equipment 220b may process the data to render a presentation of the content. During the rendering of the presentation, feedback may be provided by the users and/or the sensors 204b, as represented via the operation 262b.

The feedback of the operation 262b may be utilized by the feedback and adjustment component 224b to identify any deficiencies, or suboptimal conditions, that may be present/occurring during the rendering of the presentation. For example, distortions caused by moisture may be identified by the feedback and adjustment component 224b. As part of the operation 262b, the feedback and adjustment component 224b may identify a perceived lack of interest (e.g., a state of boredom) on the part of one or more of the users 204b and may modify a plotline of the content, may identify special effects to be applied to the content, etc., in an effort to increase/enhance user interest.

Based on any deficiencies or suboptimal conditions identified as part of the operation 262b, the feedback and adjustment component 224b may generate one or more commands/directives in an operation 266b. The commands/directives may include an identification of adjustments to be made, such as for example an alteration of an angle of a projector/screen associated with the presentation equipment 220b (potentially relative to a user 204b), a modification of a density or intensity of a projection of the presentation equipment 220b to reduce distortion, a refinement in the data provided by the vehicle(s) 212b or the satellite(s) 208b, etc. The commands/directives may be obtained by the orchestration component 216b as part of the operation 266b.

The orchestration component 216b may be responsible for delegating the adjustments identified as part of the operation 266b. For example, and as shown via the operations 266b′, the orchestration component 216b may cause the presentation equipment 220b, the vehicle(s) 212b, and/or the satellite(s) 208b to engage in one or more adjustments. The orchestration component 216b may coordinate the adjustments amongst the various entities as part of the operation 266b′ to ensure that the adjustments amongst the entities are synchronized or coordinated with respect to one another as appropriate under the circumstances/conditions.

The operations 262b, 266b, and 266b′ may be executed as part of a loop, whereby feedback that is obtained may drive/control/cause further adjustments. In this respect, a quality in the rendering of the presentation may be maintained at sufficiently high levels (e.g., may be maintained at levels that exceed a threshold) over the course of the presentation, even in the event/presence of changing/dynamic conditions or events.

Once the rendering of the presentation has completed, an operation 270b (which is represented in FIG. 2B as being directed to/at: the presentation equipment 220b, the vehicle(s) 212b, the satellite(s) 208b, and/or the user(s) and sensor(s) 204b, or any combination thereof) may cause resources to be released (e.g., disabled or turned-off) and/or reallocated/redirected for other uses (e.g., other renderings or presentations). In some embodiments, the operation 270b may include launching/initiating one or more promotional campaigns that may encourage or incentivize a consumption of additional content via one or more other presentations.

While for purposes of simplicity of explanation, the respective processes are shown and described as a series of arrows in FIG. 2B, it is to be understood and appreciated that the claimed subject matter is not limited by the order of the arrows, as some arrows/operations may occur in different orders and/or concurrently with other arrows/operations from what is depicted and described herein. Moreover, not all illustrated arrows/operations may be required to implement the methods/methodological acts described herein. Still further, while the various arrows/operations are shown in FIG. 2B as being transmitted/provided from a source to one or more destinations, the arrows/operations may be provided from a different source and/or may be provided to one or more other/different destinations in some embodiments. Furthermore, one or more intermediaries may be used in a conveyance of, e.g., data, a command/directive, etc., between a source and a destination.

Aspects of this disclosure may utilize one or more devices or vehicles, such as for example one or more satellites, spacecraft (e.g., drones), etc., to create a projected, unified image or volume for one or more observers (e.g., one or more terrestrial observers). In some embodiments, detection and orientation planning/controls may be provided/utilized in respect of one or more identified users of a network, a system, or a service. Values for one or more parameters associated with a user (such as for example a location of the user, a viewing angle of the user, etc.) may be identified/determined as part of presenting content (e.g., audio content, visual content, etc.) to the user. In some embodiments, content that is presented/rendered may include two-dimensional content, three-dimensional content, etc.

In some embodiments, one or more projection/display surfaces may be identified for presenting content. Aspects of a presentation of the content may be coordinated amongst the various surfaces, in terms of time and/or location, to enhance (e.g., optimize) one or more qualities of the presentation (such as for example a smoothness of the presentation, a data-richness of the presentation, etc.). In some embodiments, one or more adjustments/adaptations may be undertaken in response to/based on an occurrence of one or more events or conditions (e.g., user mobility, presentation surface or vehicular mobility, changes in an environment (e.g., changes in weather, such as a density of moisture/mist/fog), etc.) to enhance a quality or characteristic of a presentation or rendering. Relative to conventional technologies, aspects of the disclosure may reduce latency in accordance with such adjustments/adaptations to enhance the quality (e.g., the smoothness in playback) of one or more presentations/renderings.

As set forth herein, aspects of this disclosure may provide for a coordination of one or more displays (e.g., one or more optical displays) across one or more entities (e.g., one or more satellites). In this respect, in some embodiments a projection of visual content may be provided/obtained anywhere in the world, with characteristics (e.g., intensity, fidelity, etc.) controlled by a central controller, by multiple entities (such as for example in relation to a peer-to-peer network), etc.

Aspects of this disclosure facilitate highly interactive and dynamic presentations of content. In some embodiments, optics from an airborne vehicle (e.g., a satellite, a drone, an aircraft, etc.) may be used to augment/supplement data sourced/obtained from one or more terrestrial sources. Collectively, a high refresh-rate may be realized to enhance the quality of one or more presentations/renderings.

In some embodiments, a projection of content in respect of one or more displays/surfaces (such as for example an identifiable contour of a wall, a cloud with an identified dimension (e.g., thickness), a satellite dish, etc.) may be provided. In some embodiments, data associated with the content may be distributed amongst various entities, and the data may be provisioned by such entities in a synchronized/orchestrated manner to ensure a quality presentation.

In some embodiments, light pattern techniques, such as a time of flight technique, may be used to perform a mapping (e.g., a three-dimensional mapping) of terrestrial objects. Such a mapping may be enhanced (e.g., may be provided with a higher fidelity) relative to a ground-based radar system.

Aspects of this disclosure may facilitate trickplay capabilities in relation to a rendering/presentation of content, such as for example pause/freeze-frame, rewind, etc. As illustrative examples, such trickplay capabilities may be provided in respect of skyward presentations, such as fireworks, lightning storms, colorful sunsets, and the like. In this regard, aspects of the disclosure may ensure that a user is able to observe a given event, even if the user is distracted at a time that the event initially occurs. Still further, aspects of trickplay capabilities (inclusive of rewind/replay) may facilitate study (e.g., scientific observations/examinations) of one or more events or conditions. Of course, aspects of this disclosure may be applied to other types/kinds of environments, including terrestrial environments, marine environments, outer space, and the like.

In some embodiments, one or more presentations or renderings may be utilized to simulate conditions that would likely occur in response to one or more events. For example, patterns in human behavior may be identified in accordance with a simulated emergency situation. In this regard, aspects of this disclosure may facilitate identifying regional or governmental emergency-preparedness planning/operations.

In some instances, near-field and far-field optics may be used in relation to a satellite. In some embodiments, ambient light from an optical light emitting diode (LED) or an infrared (IR) array on a device may be combined with light that is projected via one or more beams.

Aspects of this disclosure may be utilized in connection with one or more applications. For example, aspects of this disclosure may be utilized to increase/enhance a distribution/dissemination of information, such as for example in relation to public service announcements, broadcast television programs, and the like. In some embodiments, content that is distributed may include media content, such as for example one or more programs (e.g., television shows), movies, music, etc. In some embodiments, advertising may be facilitated, whereby one or more advertisements may be provisioned to one or more users. In some embodiments, one or more targeted advertising techniques may be utilized to enhance an effectiveness or efficiency of advertisements in respect of one or more users. In some embodiments, sponsors or creators/distributors of advertisements may bid on inventory (e.g., commercial breaks) associated with one or more content items in seeking to have their advertisements populate the inventory. In this respect, aspects of this disclosure may facilitate/provide a marketplace for promoting one or more goods or services.

In some embodiments, one or more user or device profiles may be utilized in relation to presenting/rendering content. For example, a user profile may identify/include: a log of media consumed by a user, requested future recordings of media, a travel schedule/itinerary, a schedule of activities (e.g., meetings), purchase activities/decisions, online activities (e.g., emails, texts, social media activities, etc.), user preferences, communication activities engaged in by the user, etc. A device profile, which may be based at least in part on a make and model number, an IP address, a MAC address, information in a subscriber identity module (SIM), etc., may identify one or more capabilities of a device (e.g., a user device, a satellite, a drone, etc.). Based on the capabilities, characteristics/qualities of a presentation/rendering may be identified or adapted.

Aspects of the disclosure may facilitate a catalog/library of content that may be selected by a user for presentation or rendering. In some embodiments, such a selection may enable an on-demand presentation, potentially subject to payment of, e.g., a license or subscription fee. In some embodiments, one or more beamforming techniques may be utilized to ensure that only authorized users obtain access to the presentation/rendering. Aspects or parameters of the presentation/rendering, such as an angle, shape, position/location, etc., may be controlled to ensure that unauthorized users do not obtain access to, or perceive, the presentation/rendering.

Aspects of this disclosure may incorporate feedback (e.g., user feedback) to customize/tailor a presentation of content. Such feedback may be used to enhance one or more qualities of the presentation. To the extent that user feedback is utilized, the user feedback may include active feedback (such as for example user responses to surveys, questionnaires, and the like) and/or passive feedback (e.g., via passive monitoring techniques, such as for example gaze tracking, a monitoring of mobile device activity, and the like). The feedback may be incorporated as part of one or more machine learning or artificial intelligence algorithms to enhance the qualities of the presentation, to enhance an effectiveness or user interest in a presentation, etc.

In some embodiments, characteristics associated with one or more devices may be modified to provide for one or more particular/identifiable properties/characteristics of a presentation. As an illustrative example, a projected image obtained via a light source/emitter may be captured by a camera, and an output of the camera may be examined/analyzed to enhance a characteristic of (e.g., a color associated with) the image via a modification of one or more parameters of the light source/emitter. In this regard, adaptations may be made to ensure that a sufficient quality (e.g., quality greater than a threshold) is obtained.

In some embodiments, a coordination and deployment of different types of materials may be utilized/provided to color-match an area or region. For example, a determination may be made that a particular shade of blue or red should be utilized in a given scene/context, and a device (e.g., a ground device) may be controlled to change properties (e.g., translucence, reflectivity, absorption, etc.) in sync with a projection.

Aspects of the disclosure may be used to provide special effects to one or more objects, inclusive of one or more virtual objects and/or one or more physical/tangible objects. For example, aspects of the disclosure may be used to highlight, blur, shade, camouflage/mask/cloak, reorient, resize, etc., an appearance of one or more objects.

As described above, in some embodiments one or more beamforming techniques may be utilized to provision audio and/or visual content to one or more users. In some embodiments, at least some of the data associated with a presentation/rendering of content may be sourced from a satellite. In some embodiments, at least a portion of the content (e.g., a portion of audio) may be pre-recorded or downloaded to a device (e.g., a user device) to ensure synchronization between different aspects of the content (e.g., to ensure synchronization between audio and visual aspects) during presentation.

One or more priority schemes may be utilized to determine/identify characteristics associated with a presentation. To demonstrate, where multiple users are located in an environment where content is to be presented (such as for example in relation to an audience located in a stadium or an arena), user responses to poll questions (which may be facilitated by respective user devices) may dictate parameters/characteristics associated with the presentation of the content. For example, a majority-rules scheme may be utilized to select parameters/characteristics for the presentation. In some embodiments, conflicts in terms of preferences (e.g., user preferences) may be arbitrated/adjudicated based on payment of a fee, an agreement to receive advertising of a given type/kind or from a given sponsor, etc.

As set forth herein, one or more commands or directives may cause a vehicle, a communication device, etc., to assume or be assigned a value in relation to one or more parameters. Data may be provisioned based on the value of the parameter, where such data may be associated with/representative of one or more content items.

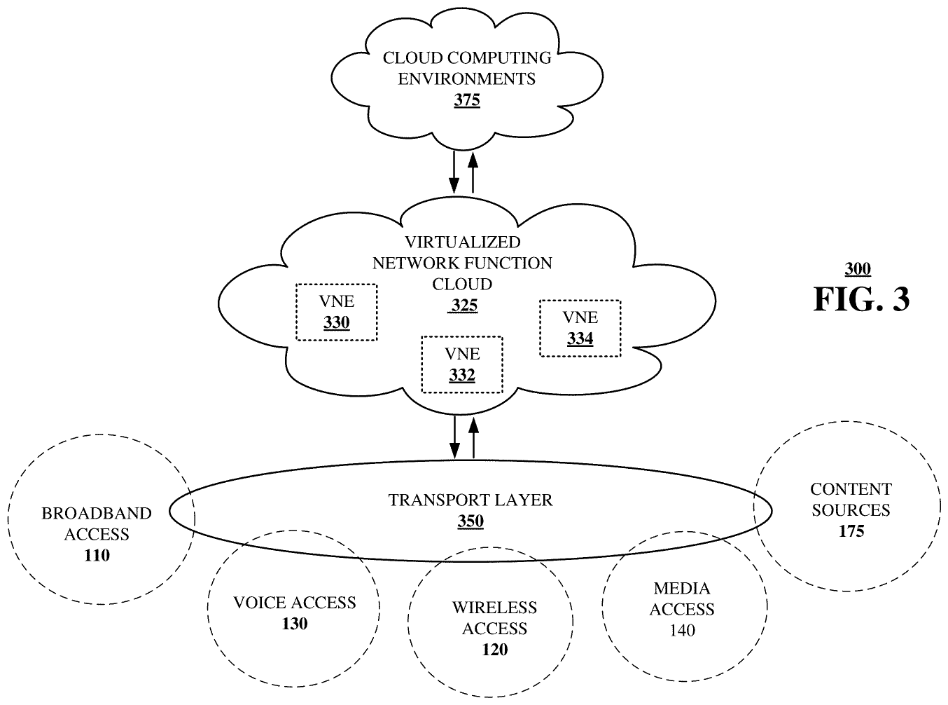

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and the subsystems and function of system 200b presented in FIGS. 1, 2A, and 2B. For example, virtualized communication network 300 can facilitate in whole or in part receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment. Virtualized communication network 300 can facilitate in whole or in part identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. Virtualized communication network 300 can facilitate in whole or in part causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

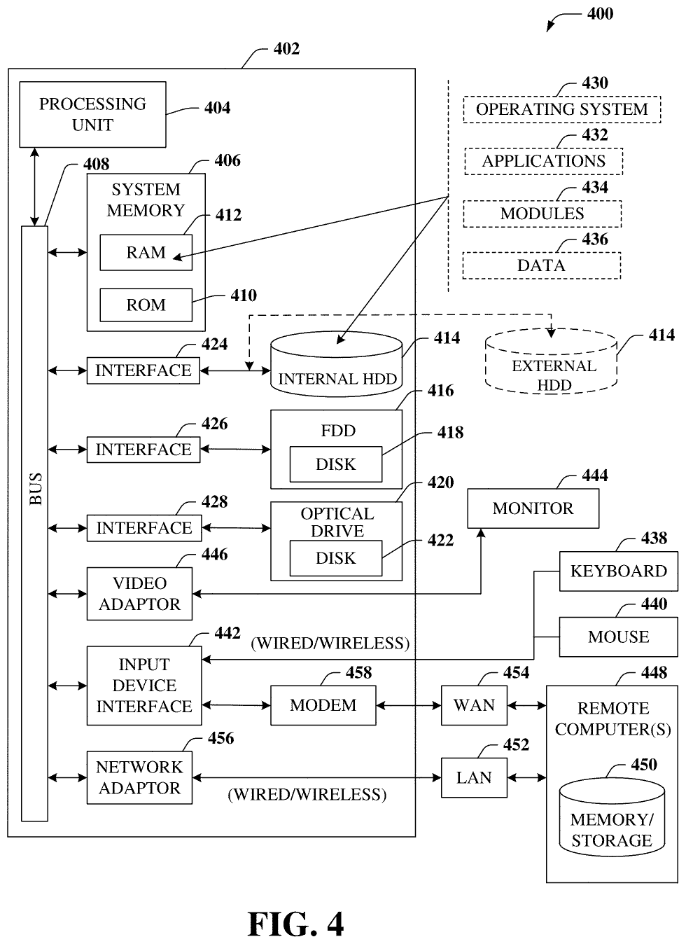

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment. Computing environment 400 can facilitate in whole or in part identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. Computing environment 400 can facilitate in whole or in part causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

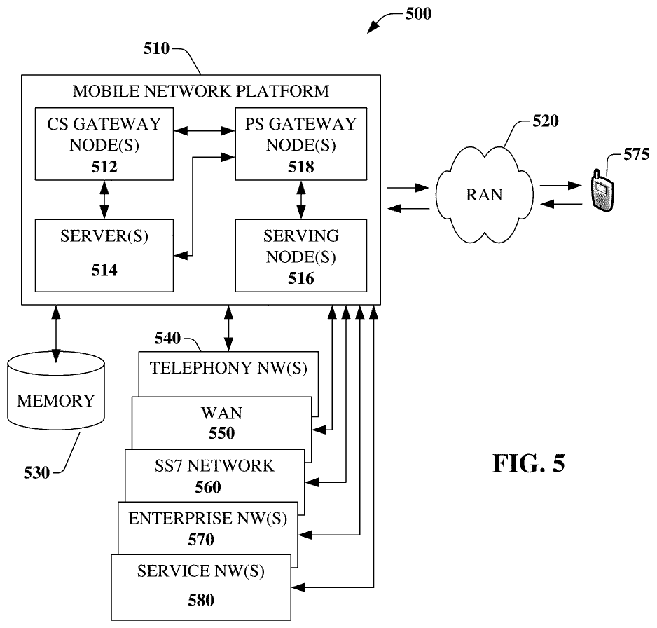

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment. Platform 510 can facilitate in whole or in part identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. Platform 510 can facilitate in whole or in part causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

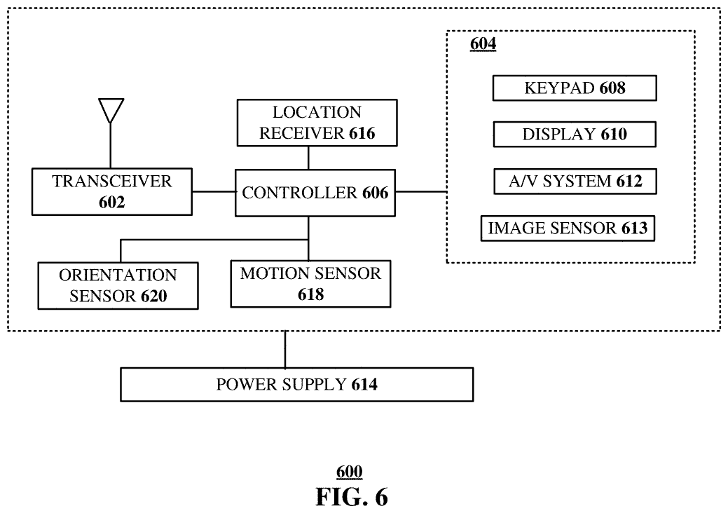

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving a first request from a first user for a content item, determining, based on the receiving of the first request, that the first user is authorized to access the content item, identifying, based on the determining that the first user is authorized to access the content item, a first value for a first parameter associated with a first satellite, identifying, based on the determining that the first user is authorized to access the content item, a second value for a second parameter associated with a first vehicle, providing a first command comprising the first value to the first satellite to cause the first satellite to provide first data associated with the content item to a presentation equipment, and providing a second command comprising the second value to the first vehicle to cause the first vehicle to provide second data associated with the content item to the presentation equipment. Computing device 600 can facilitate in whole or in part identifying a plurality of users in relation to a presentation of a first content item, identifying a respective location of each user of the plurality of users relative to a presentation equipment, assigning a first value for a first parameter of the presentation equipment based on the identifying of the respective location of each user, assigning a second value for a second parameter of a satellite based on the identifying of the respective location of each user, and commanding the satellite to provide first data to the presentation equipment, in accordance with the second value, to facilitate the presentation of the first content item. Computing device 600 can facilitate in whole or in part causing a transmission of first data from a first satellite and second data from a second satellite to facilitate a presentation of a first portion of a content item via presentation equipment, obtaining first feedback from a sensor and second feedback from a user equipment, wherein the first feedback and the second feedback are generated during the presentation of the first portion of the content item, identifying at least one parameter to modify based on an analysis of the first feedback and the second feedback, wherein the at least one parameter is associated with the presentation equipment, the first satellite, the second satellite, or any combination thereof, commanding a modification of the at least one parameter based on the identifying of the at least one parameter to modify, and subsequent to the commanding of the modification of the at least one parameter, causing a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a first request from a first user for a content item;
determining, based on the receiving of the first request, that the first user is authorized to access the content item;
identifying, based on the determining that the first user is authorized to access the content item, a first value for a first parameter associated with a first satellite;
identifying, based on the determining that the first user is authorized to access the content item, a second value for a second parameter associated with a first vehicle;
providing a first command comprising the first value to the first satellite to cause the first satellite to provide first data associated with the content item to a presentation equipment; and
providing a second command comprising the second value to the first vehicle to cause the first vehicle to provide second data associated with the content item to the presentation equipment.

2. The device of claim 1, wherein the presentation equipment includes a display screen, a wall, a cloud, a satellite dish, a speaker, or any combination thereof, and wherein the presentation equipment is configured to render a presentation of the content item based on the first data and the second data.

3. The device of claim 1, wherein the first vehicle includes a drone.

4. The device of claim 1, wherein the first parameter pertains to a location of the first satellite, a frequency band utilized by the first satellite, a power level utilized by the first satellite, a modulation scheme utilized by the first satellite, a security scheme utilized by the first satellite, or any combination thereof.

5. The device of claim 4, wherein the second parameter pertains to a location of the first vehicle, a frequency band utilized by the first vehicle, a power level utilized by the first vehicle, a modulation scheme utilized by the first vehicle, a security scheme utilized by the first vehicle, or any combination thereof.

6. The device of claim 1, wherein the first vehicle obtains the second data from the first satellite, a second satellite, a second vehicle, or any combination thereof, in accordance with the second command.

7. The device of claim 1, wherein the operations further comprise:
identifying a physical object located in an environment of the first user,
wherein the first data, the second data, or a combination thereof, is based on the identifying of the physical object.

8. The device of claim 1, wherein the operations further comprise:
identifying, based on the determining that the first user is authorized to access the content item, a third value for a third parameter associated with the presentation equipment,
wherein the first data, the second data, or a combination thereof, is based on the identifying of the third value.

9. The device of claim 1, wherein the operations further comprise:
obtaining feedback during a presentation of the content item in accordance with the first data and the second data.

10. The device of claim 9, wherein the obtaining of the feedback comprises obtaining first feedback from a sensor.

11. The device of claim 10, wherein the obtaining of the feedback comprises obtaining second feedback from the first user, third feedback from a second user, or a combination thereof.

12. The device of claim 11, wherein the operations further comprise:
identifying, based on the feedback, a third value for the first parameter, wherein the third value is different from the first value; and
providing a third command comprising the third value to the first satellite to cause the first satellite to provide third data associated with the content item to the presentation equipment.

13. The device of claim 11, wherein the operations further comprise:
identifying, based on the feedback, a third value for the second parameter, wherein the third value is different from the second value; and
providing a third command comprising the third value to the first vehicle to cause the first vehicle to provide third data associated with the content item to the presentation equipment.

14. The device of claim 1, wherein the operations further comprise:
determining that a presentation of the content item has ended; and
responsive to the determining that the presentation of the content item has ended, redirecting the first satellite, the first vehicle, the presentation equipment, or any combination thereof.

15. The device of claim 1, wherein the first data and the second data correspond to visual content associated with the content item, and wherein the operations further comprise:
synchronizing third data corresponding to audio content associated with the content item to the first data and the second data.

16. A non-transitory machine-readable medium, comprising executable instructions that, when executed by a processing system including a processor, facilitate performance of operations, the operations comprising:
identifying a plurality of users in relation to a presentation of a first content item;
identifying a respective location of each user of the plurality of users relative to a presentation equipment;
assigning a first value for a first parameter of the presentation equipment based on the identifying of the respective location of each user;
assigning a second value for a second parameter of a satellite based on the identifying of the respective location of each user; and
commanding the satellite to provide first data to the presentation equipment, in accordance with the second value, to facilitate the presentation of the first content item.

17. The non-transitory machine-readable medium of claim 16, wherein the operations further comprise:
identifying a first user profile associated with a first user of the plurality of users, wherein the first user profile identifies: a preference of the first user, a social media activity of the first user, media consumed by the first user, communication sessions engaged in by the first user, purchase activities engaged in by the first user, or any combination thereof;
selecting a first advertisement based on the identifying of the first user profile; and
commanding the satellite to provide second data representative of the first advertisement to the presentation equipment to cause the presentation equipment to present the first advertisement.

18. The non-transitory machine-readable medium of claim 16, wherein the operations further comprise:
monitoring a behavior of a first user of the plurality of users during the presentation of the first content item;
identifying, based on the monitoring, a second content item;
commanding the satellite to provide second data to the presentation equipment to facilitate a presentation of the second content item; and
commanding a drone to provide third data to the presentation equipment to facilitate the presentation of the second content item.

19. A method, comprising:
causing, by a processing system including a processor, a transmission of first data from a first satellite and second data from a second satellite to facilitate a presentation of a first portion of a content item via presentation equipment;
obtaining, by the processing system, first feedback from a sensor and second feedback from a user equipment, wherein the first feedback and the second feedback are generated during the presentation of the first portion of the content item;
identifying, by the processing system, at least one parameter to modify based on an analysis of the first feedback and the second feedback, wherein the at least one parameter is associated with the presentation equipment, the first satellite, the second satellite, or any combination thereof;
commanding, by the processing system, a modification of the at least one parameter based on the identifying of the at least one parameter to modify; and
subsequent to the commanding of the modification of the at least one parameter, causing, by the processing system, a transmission of: third data from the first satellite, fourth data from the second satellite, fifth data from a vehicle, sixth data from the user equipment, seventh data from a second user equipment, eighth data from a server, or any combination thereof, to facilitate a presentation of a second portion of the content item via the presentation equipment.

20. The method of claim 19, further comprising:
engaging, by the processing system, a trickplay command that causes at least the first portion of the presentation of the content item to be paused or rewound.
